(19) United States
(12) Patent Application Publication
(10) Pub. No.: US 2011/0075634 A1
(43) Pub. Date: Mar. 31, 2011

(54) HANDOVER METHOD, RADIO BASE STATION, AND MOBILE TERMINAL

(76) Inventor: Hidenori Maruyama, Tokyo (JP)

(21) Appl. No.: 12/995,602

(22) PCT Filed: May 14, 2009
(86) PCT No.: PCT/JP2009/058984

§ 371 Date: Dec. 1, 2010

(30) Foreign Application Priority Data
Jun. 4, 2008 (JP) 2008-146878

(51) Int. Cl. H04W 4/00

(52) U.S. Cl. 370/331

(57) ABSTRACT

It is determined whether or not to perform a handover to switch a destination of connection of a mobile terminal (10) from a first radio base station (20) to a second radio base station (30), the mobile terminal holding data communications with the first radio base station (20) by MIMO communications using a plurality of transmission channels. If it is determined to perform the handover, the data communications between the mobile terminal and the first base station are suspended, and communications pertaining to the handover are started between the mobile terminal and each of the base stations by ordinary communications using a single transmission channel. After the completion of the handover, communication mode between the mobile terminal and the second radio base station is switched from the ordinary communications to MIMO communications.

### TECHNICAL FIELD

The present invention relates to a handover of a terminal in mobile communications including MIMO (Multi Input Multi Output) communications.

### BACKGROUND ART

MIMO communications are attracting attention as a communication technology for increasing the capacity of mobile communications. Transmitting/receiving devices for MIMO communications are provided with an array antenna which includes a plurality of antennas. MIMO communications transmit different pieces of information data from the respective antennas of the array antenna at the same frequency in parallel by utilizing differences in the transmission conditions between the individual antennas and the other party of the communication. The radio signals are thereby spatially multiplexed for increased transmission quantity.

FIG. 6 shows a configuration example of an MIMO transceiver 1 with a four-system array antenna. A transmission unit 2 of the MIMO transceiver 1 includes: an S/P conversion unit 2a which performs serial/parallel conversion of transmission signals; and modulation units 2b and RF (Radio Frequency) transmission units 2c which are arranged for the respective antennas of an array antenna 4. A reception unit 3 includes: RF reception units 3a and demodulation units 3c which are arranged for the respective antennas of the array antenna 4; a signal separation circuit 3b for separating the reception signals resulting from the RF reception units 3a and supplying the resultant to the demodulation units 3c; and a P/S conversion unit 3d which performs parallel/serial conversion of the demodulated signals. The signal separation circuit 3b is a circuit specific to the reception unit 3 for MIMO communications.

MIMO communications are intended to transmit a large amount of data seamlessly, whereas the seamless transmission can be hindered at the time of a handover in a terminal, i.e., when the terminal switches a base station to another base station for movement or other reasons. Originally, communication environment where a handover is needed is often unstable because of radio wave interference between a plurality of base stations. During a MIMO handover, the signal separation circuit (FIG. 6: 3b) can thus fail to properly separate the reception signals, causing transmission losses such as retransmission and a greater instantaneous interruption time.

Examples of the technologies related to a MIMO communication handover include one described in PTL 1 below. The literature describes the technology for improving the throughput in handover areas to expand the cell coverage.

### CITATION LIST

### Patent Literature

{PTL 1} JP-A-2006-157848

### Non-Patent Literature

{NPL 1} 3GPP, “TS36.300 V8.3.0,” [online], December 2007, [Searched on 20 May 2008], the Internet <http://www.3gpp.org/ftp/Specs/html-info/36300.htm>, pp. 13-14, FIG. 4
{NPL 2} 3GPP, “TS 36.300 V8.3.0,” [online], December 2007, [Searched on 20 May 2008], the Internet <http://www.3gpp.org/ftp/Specs/html-info/36300.htm>, pp. 40-42, FIG. 10.1.2.1

### SUMMARY OF INVENTION

### Technical Problem

According to the technology of the foregoing PTL 1, the MIMO communication throughput at handover time improves. As described in the literature, such an improvement, however, is predicated on complicated analyses of the reception signals. As described with reference to FIG. 6, the MIMO transceiver (1) needs the modulation/demodulation circuits (2b, 3c), the RF signal processing circuits (2c, 3a), and the like for the respective antennas. This tends to increase the circuit scale and the power consumption. The application of the configuration of the foregoing literature 1 to such a MIMO transceiver can thus cause the problem of a further increase in the circuit scale and power consumption of each node.

It is an object of the present invention to provide technology for preventing each node from increasing in circuit scale and power consumption in order to facilitate a handover of the mobile terminal in MIMO communications.

### Solution to Problem

A handover method according to the present invention is a method including: determining whether or not to perform a handover to switch a destination of connection of a mobile terminal from a first radio base station to a second radio base station, the mobile terminal holding data communications with the first radio base station by MIMO (Multi Input Multi Output) communications using a plurality of transmission channels; suspending, if it is determined to perform the handover, the data communications between the mobile terminal and the first radio base station and starting communications pertaining to the handover between the mobile terminal and each of the first and second radio base stations by ordinary communications using a single transmission channel; and switching communication mode between the mobile terminal and the second radio base station from the ordinary communications to MIMO communications after completion of the handover.

A radio base station according to the present invention includes: a transmission and reception unit that radioly performs MIMO (Multi Input Multi Output) communications using a plurality of transmission channels and ordinary communications using a single transmission channel; and a control unit that determines whether or not to perform a handover to switch a destination of connection of a mobile terminal to another station, the mobile terminal holding data communications with the own station by MIMO communications, suspends, if it is determined to perform the handover, the data communications between the mobile terminal and the own station and starts communications pertaining to the handover between the mobile terminal and the own station by ordinary communications using a single transmission channel, and switches communication mode between a mobile terminal and the own station from ordinary communications to MIMO communications after completion of another handover, a destination of connection of the mobile terminal being switched from another station to the own station by the ordinary communications for the another handover.

A mobile terminal according to the present invention is a mobile terminal including a transmission and reception unit that radioly performs MIMO (Multi Input Multi Output) communications using a plurality of transmission channels and ordinary communications using a single transmission channel. When performing a handover to switch a destination of connection to a second radio base station while holding data communications with a first radio base station by MIMO communications, the mobile terminal starts communications pertaining to the handover between the own terminal and each of the first and second radio base stations by ordinary communications, and switches communication mode between the own terminal and the second radio base station from the ordinary communications to MIMO communications after completion of the handover.

### ADVANTAGEOUS EFFECTS OF INVENTION

According to the present embodiment, it is possible to prevent each node from increasing in circuit scale and power consumption in order to facilitate a handover of the mobile terminal during MIMO communications.

### BRIEF DESCRIPTION OF DRAWINGS

FIG. 1 A block diagram of a system according to an embodiment of the present invention.

FIG. 2 A block diagram showing the configuration of each base station and mobile terminal according to the embodiment of the present invention.

FIG. 3 An explanatory diagram about antenna switching according to the embodiment of the present invention.

FIG. 4 A sequence diagram showing the operation of the embodiment of the present invention.

FIG. 5 A sequence diagram showing the operation of another embodiment of the present invention.

FIG. 6 A block diagram showing the configuration of a transceiver for MIMO communications.

### DESCRIPTION OF EMBODIMENTS

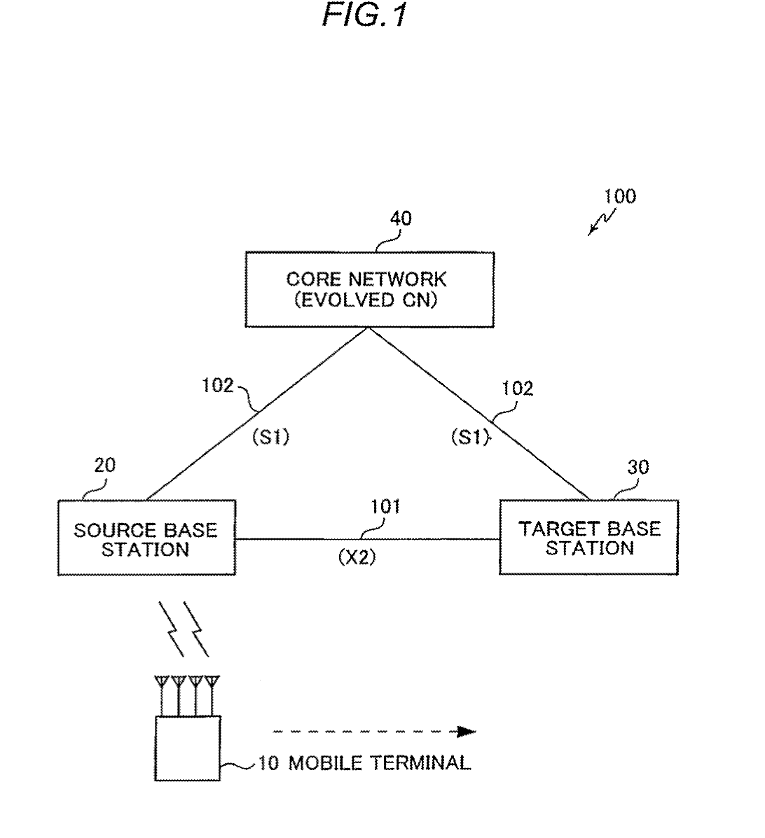

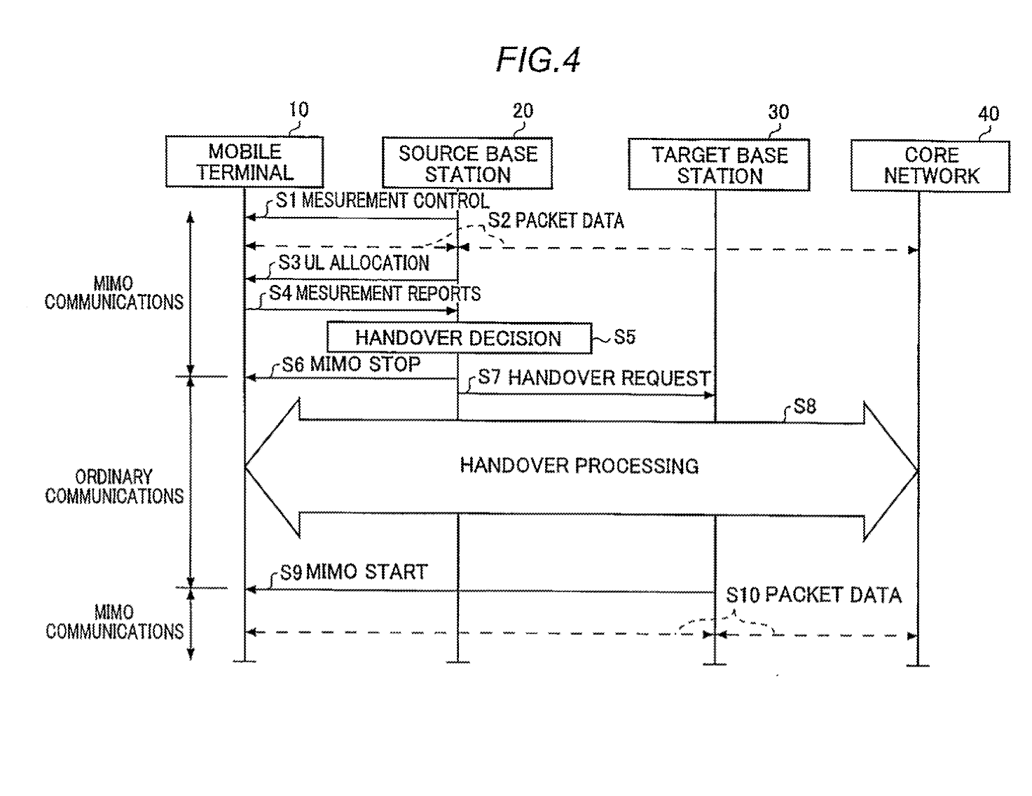

FIG. 1 shows the system configuration according to an embodiment of the present invention. The system 100 of the present embodiment is based on the configuration of an LTE (Long Term Evolution)/SAE (System Architecture Evolution) network which has been discussed in 3GPP (3rd Generation Partnership Project). An example of the LTE/SAE network configuration is described in NPL 1 (FIG. 4).

The system 100 includes: a source base station 20 and a target base station 30 which are “eNBs” (E-UTRAN NodeBs) constituting “E-UTRAN” (Evolved Universal Terrestrial Radio Access Network) described in NPL 1; a core network (Evolved CN) 40 which includes “MME/S-GW” (Mobility Management Entity/Serving Gateway) described in the same literature; and a mobile terminal 10 which attempts a handover from the source base station 20 to the target base station 30. The source base station 20 is a node corresponding to the first radio base station according to the present invention. The target base station 30 is one corresponding to the second radio base station.

The foregoing “eNBs,” or the source base station 20 and the target base station 30, are nodes in which part of 3G network RNC (Radio Network Controller) functions and “NodeB” (radio base station) functions are integrated. The core network 40 is connected to an external network such as the Internet.

The source base station 20 and the target base station 30 are mutually connected by an interface 101 called “X2.” The base stations 20 and 30 and the core network 40 are connected by interfaces 102 called “S1.” The interfaces such as “X2” and “S1” are logical ones. For physical connections, “S1” (102) may also be used for “X2” (101).

If, in the system 100, the mobile terminal 10 is currently connected with the source base station 20, downstream data from the external network to the mobile terminal 10 is delivered to the mobile terminal 10 from the core network 40 through the source base station 20. At the time of a handover of the mobile terminal 10, i.e., when the mobile terminal 10 switches the connection from the source base station 20 to the target base station 30, the following procedure is performed.

Initially, the source base station 20 once suspends the data communications with the mobile terminal 10, and transfers pieces of downstream data from the core network 40 to the target base station 30 through the interface 102 (X2). The pieces of downstream data are data that have not been transmitted to the mobile terminal 10 yet or data that receipt acknowledgement has not been received from the mobile terminal 10 yet. The target base station 30 transfers the data that is received from the source base station 20 to the mobile terminal 10 which is handed over from the source base station 20. Consequently, the mobile terminal 10 can continue the once-suspended data communications with the target base station 30.

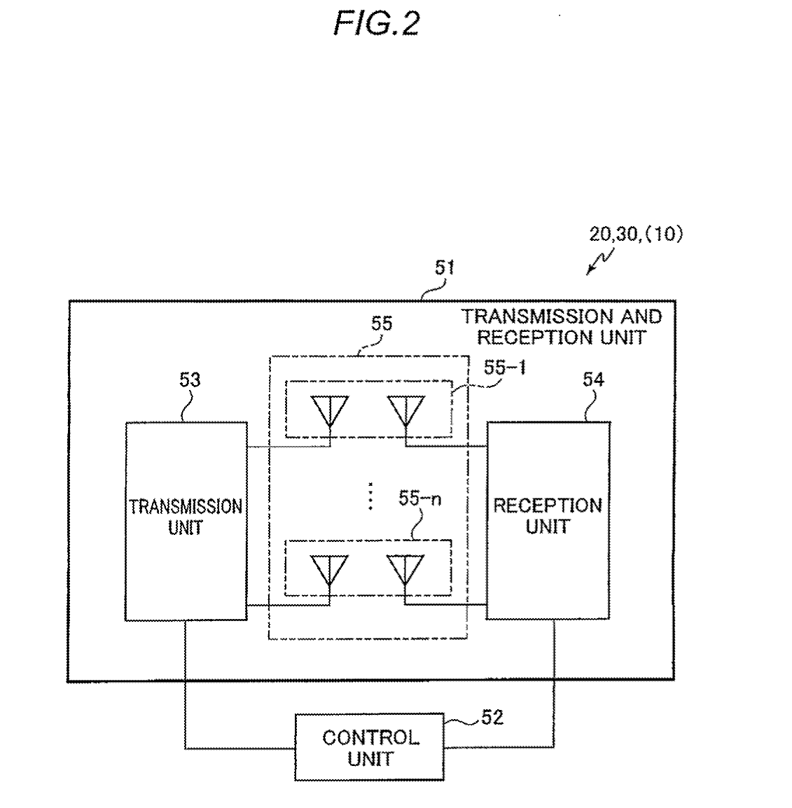

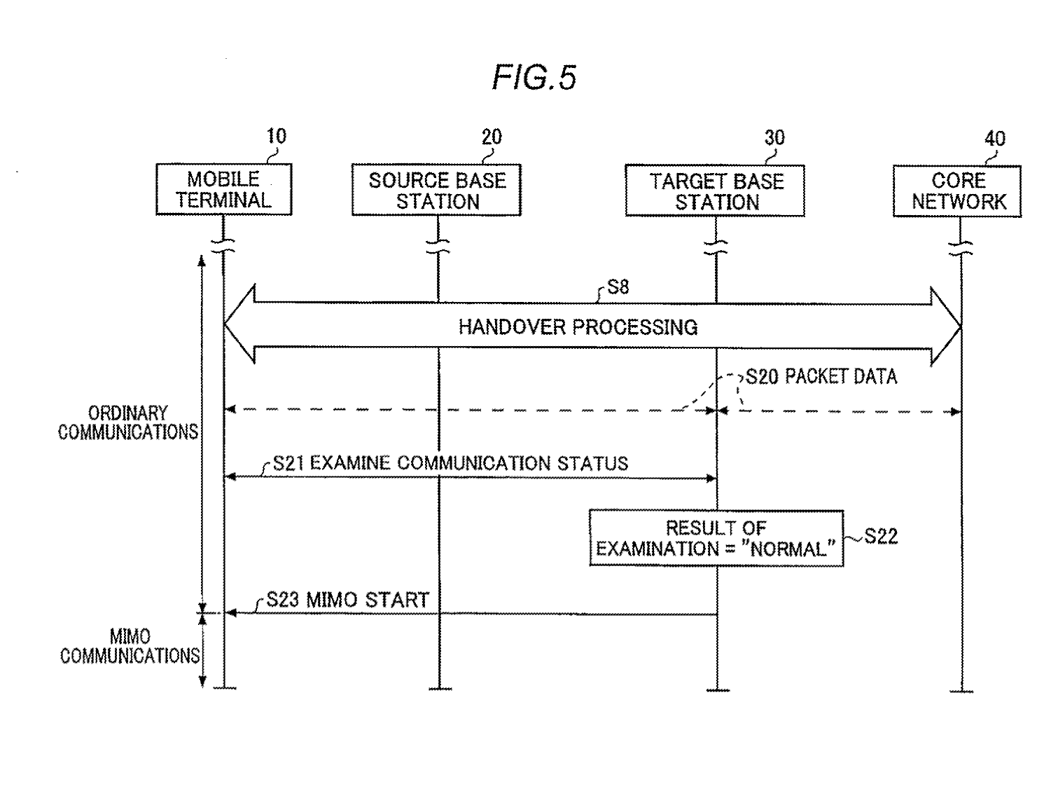

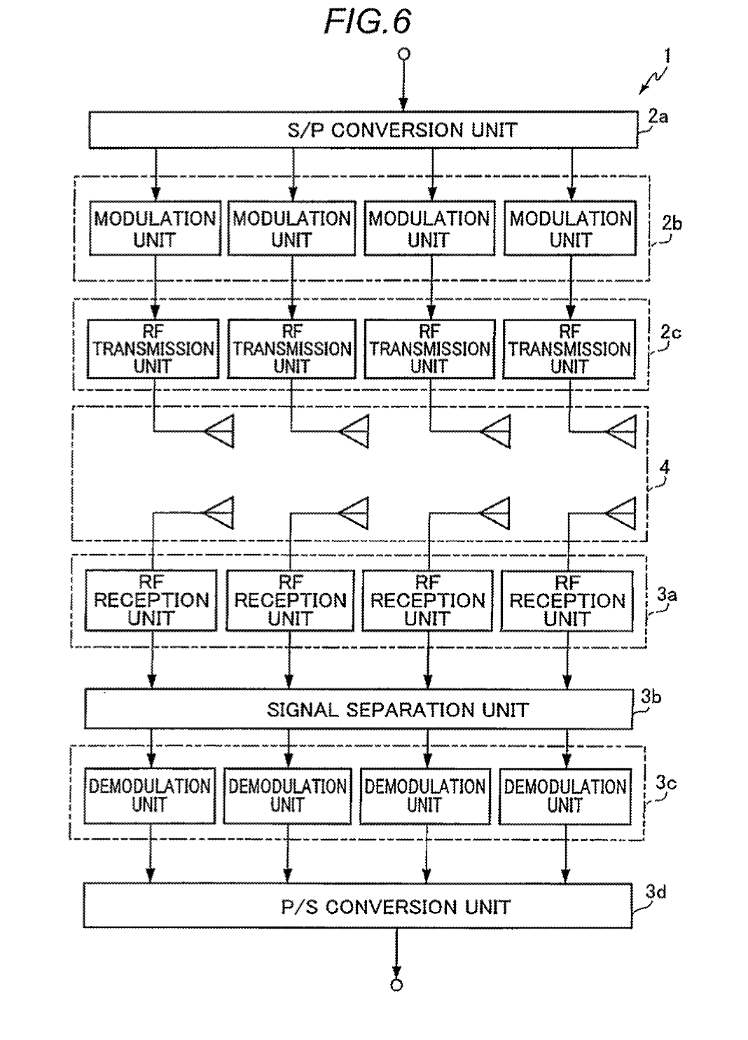

FIG. 2 shows the configuration of the base stations 20 and 30. The shown configuration is in charge of radio communications between each base station and the mobile terminal 10. Similar configuration is applied to the mobile terminal 10. A transmission and reception unit 51 is carries out signal processing for radio communications including ordinary communications through a single transmission channel and MIMO communications mentioned above. The transmission and reception unit 51 has the same basic configuration as that of the MIMO transceiver 1 of FIG. 6. Specifically, a transmission unit 53, a reception unit 54, and an array antenna 55 including antennas 55-1, . . . , 55-n of the transmission and reception unit 51 correspond to the transmission unit 2, the reception unit 3, and the array antenna 4 of FIG. 5.

A control unit 52 controls the mode of the radio communications to be performed by the transmission and reception unit 51. For MIMO communications, the control unit 52 instructs the transmission and reception unit 51 to use all or the plurality of systems of the array antenna 55 for communication. For ordinary communications through a single transmission channel, the control unit 52 instructs the transmission and reception unit 51 to use any one of the systems of antennas of the array antenna 55 for communication.

If the control unit 52 belongs to a base station 20 or 30, the control unit 52 determines whether the mobile terminal 10 in connection with the own station by MIMO communications needs to be handed over to another station. If a handover is needed, the control unit 52 switches the communication mode with the mobile terminal 10 from MIMO communications to ordinary communications, and executes a series of handover processing by ordinary communications.

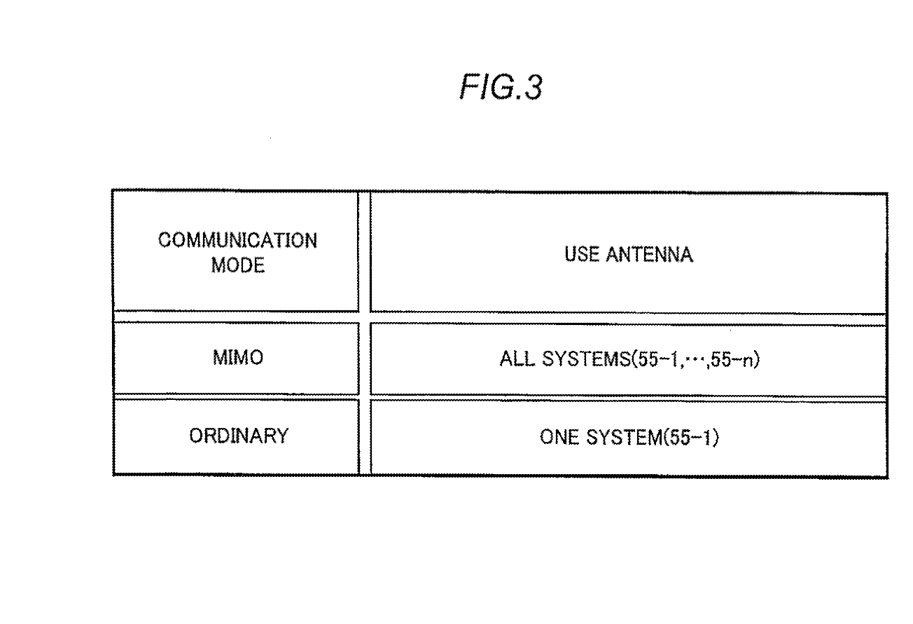

For the sake of switching of the communication mode, information on the correspondence between communication modes and antennas such as shown in FIG. 3 is set in the base stations 20 and 30 and the mobile terminal 10. The shown setting shows that all the systems (55-1, . . . , 55-n) of the array antenna 55 are used for MIMO communications, and only one of the systems of antennas (55-1) of the array antenna 55 is used for ordinary communications. It should be appreciated that the shown setting is just an example, and which antennas to use may be arbitrarily set depending on the numbers of antennas needed for MIMO communications and ordinary communications, respectively. The antennas to use and the number of antennas for MIMO communications may be changed depending on the quality needed of the current communications.

Referring to the sequence shown in FIG. 4, the operation of the present embodiment will be described. As will be described, the sequence described in NPL 2 (FIG. 10.1.2.1) is applied to part of the shown sequence.

Suppose that the mobile terminal 10 and the source base station 20 are currently holding MIMO data communications with each other. In order to determine whether the mobile terminal 10 needs to be handed over, the source base station 20 performs the processing of checking reception status of radio waves of the mobile terminal 10 (steps S1 to S4). Such processing is the same as the one described in NPL 2. More specifically, the source base station 20 transmits “Measurement Control” to the mobile terminal 10 (S1). “Packet Data” is exchanged between the mobile terminal 10 and the source base station 20, and between the source base station 20 and the core network 40 (S2). The source base station 20 then transmits “UL (uplink) allocation” to the mobile terminal 10 (S3), and the mobile terminal 10 returns “Measurement Reports” to the source base station 20 (S4).

Suppose here that the source base station 20 determines that the mobile terminal 10 needs to be handed over (step S5). Whether or not a handover is needed can be determined, for example, based on the reception status of radio waves of the mobile terminal 10 estimated from the terminal's SIR (Signal to interference Power ratio) which is notified by the foregoing “Measurement Reports.” Specifically, the source base station 20 can be determine that a handover is needed if more than half of all the antennas fall below a reference value in SIR.

If the source base station 20 determines to perform a handover, the source base station 20 stops the data communications with the mobile terminal 10, and instructs the mobile terminal 10 to switch the communication mode from MIMO to ordinary communications (step S6: “MIMO Stop”). Consequently, the mobile terminal 10 performs subsequent radio communications with the source base station 20 and the target base station 30 by ordinary communications using a single system of antennas.

The source base station 20 transmits a handover request to the target base station 30 which is the destination of the handover (step S7). While the handover request may be in the same format as with “4 Handover Request” described in NPL 2, the source base station 20 adds to the format the information that instructs the target base station 30 to perform ordinary communications with the mobile terminal 10. Recognizing the handover request from the source base station 20, the target base station 30 communicates with the mobile terminal 10 by ordinary communications.

Subsequently, the entire system (10, 20, 30, 40) performs a series of handover processing (step S8). The handover processing is the same as the procedure from “5. Admission Control” to “18. Release Resources” described in NPL 2. In the meantime, the mobile terminal 10 to be handed over from the source base station 20 to the target base station 30 communicates with each base station (20, 30) by ordinary communications.

When the resources of the source base station 20 are released to complete the handover (NPL 2, “18. Release Resources”), the target base station 30 instructs the mobile terminal 10 to switch the communication mode with the own station from ordinary communications to MIMO (step S9: “MIMO start”). The mobile terminal 10 performs subsequent communications with the target base station 30 by MIMO. Consequently, the data communications suspended at the time of the handover are resumed between the mobile terminal 10 and the target base station 30 by MIMO (step S10).

As described above, according to the present embodiment, when a handover is needed during MIMO communications, the MIMO are once switched to ordinary communications and handover processing is carried out. In general, situations where a handover of the mobile terminal (10) is needed are where the reception quality of the terminal drops. In such situations, a MIMO-based handover, if attempted, is likely to cause transmission losses such as disconnection and a packet loss.

Therefore, the handover processing is performed by ordinary communications instead of MIMO so as to reduce transmission losses that can occur during a handover. Since ordinary communications use a single system of antennas, part of the circuit configuration for MIMO communications can be utilized.

Consequently, according to the present embodiment, it is possible to prevent each node from increasing in circuit scale and power consumption in order to facilitate a handover of the mobile terminal 10 during MIMO communications. This can improve the performance of the entire system.

### Other Embodiments

In the foregoing embodiment, the communication mode is switched from ordinary communications to MIMO when the data communications are resumed after the completion of the handover. The switching timing is not limited to that of the foregoing embodiment, however. For example, the data communications may be resumed by ordinary communications, and then switched to MIMO if the communication stability is confirmed. FIG. 5 schematically shows the procedure of such an embodiment.

In FIG. 5, when the foregoing series of handover processing (step S8) is completed, the mobile terminal 10, the target base station 30, and the core network 40 resume data communications (step S20). Here, the mobile terminal 10 and the target base station 30 resume the data communication not by MIMO but by ordinary communications continuous from the handover processing.

After the data communications are resumed, it is examined whether the communications are normally performed between the mobile terminal 10 and the target base station 30 (step S21). An arbitrary method of examination may be used as long as the communication status between the mobile terminal 10 and the target base station 30 can be checked. For example, the target base station 30 may estimate the reception of the mobile terminal 10 based on an error rate that is derived from a pilot signal in the control channel, and determine whether the current communications are normal or not from the result of estimation. If the target base station 30 determines that the communications between the own station and the mobile terminal 10 are normal (step S22), the target base station 30 instructs the mobile terminal 10 to switch the communication mode from ordinary communications to MIMO (step S23: “MIMO start”).

According to the present embodiment, when the communication environment is unstable immediately after a handover, the switching to MIMO communications is suspended until the communication environment is stabilized into a normal state. The mobile terminal 10 can thus resume MIMO communications in appropriate communication environment.

It should be noted that the present invention is not limited to the foregoing embodiments. The present invention may be carried out with appropriate modifications within the scope of claims of the present application. For example, the present invention may be practiced as a computer program that corresponds to the operation of the radio base station (20, 30) or the mobile terminal (10), or a recording medium that contains the program. The foregoing embodiments have dealt with the cases where the present invention is applied to a 3GPP LTE/SAE network. However, the present invention may be applied to a conventional 3G network and networks of other standards as long as the networks are capable of radio communications including MIMO communications.

This application is based on and claims priority from prior Japanese Patent Application No. 2008-146878, filed 4 Jun. 2008, the entire contents of which are incorporated herein.

### REFERENCE SIGNS LIST

100: system
101: interface (X2)
102: interface (S1)
10: mobile terminal
20: source base station
30: target base station
40: core network
51: transmission and reception unit,
52: control unit,
53: transmission unit,
54: reception unit,
55: array antenna, and
55-1 to 55-n: antenna

1. A handover method comprising:
determining whether or not to perform a handover to switch a destination of connection of a mobile terminal from a first radio base station to a second radio base station, the mobile terminal holding data communications with the first radio base station by Multi Input Multi Output (MIMO) communications using a plurality of transmission channels;
suspending, if it is determined to perform the handover, the data communications between the mobile terminal and the first radio base station and starting communications pertaining to the handover between the mobile terminal and each of the first and second radio base stations by ordinary communications using a single transmission channel; and
switching communication mode between the mobile terminal and the second radio base station from the ordinary communications to MIMO communications after completion of the handover.

2. The handover method according to claim 1, wherein after the completion of the handover, the suspended data communications are resumed between the mobile terminal and the second radio base stations by using the switched MIMO communications.

3. The handover method according to claim 1, wherein:
after the completion of the handover, the suspended data communications are resumed between the mobile terminal and the second radio base station by ordinary communications continuous from the handover,
whether the resumed data communications are normal or not is determined; and
if the result of determination is normal, the communication mode between the mobile terminal and the second radio base station is switched from the ordinary communications to MIMO communications, and the resumed data communications are continued by the MIMO communications.

4. The handover method according to claim 1, wherein each of the first and second radio base stations is a node that is connected to Evolved Universal Terrestrial Radio Access Network (E-UTRAN) of a Long Term Evolution (LTE)/System Architecture Evolution (SAE) network.

5. A radio base station comprising:
a transmission and reception unit that radioly performs Multi Input Multi Output (MIMO) communications using a plurality of transmission channels and ordinary communications using a single transmission channel; and
a control unit that determines whether or not to perform a handover to switch a destination of connection of a mobile terminal to another station, the mobile terminal holding data communications with the own station by MIMO communications, suspends, if it is determined to perform the handover, the data communications between the mobile terminal and the own station and starts communications pertaining to the handover between the mobile terminal and the own station by ordinary communications using a single transmission channel, and switches communication mode between a mobile terminal and the own station from ordinary communications to MIMO communications after completion of another handover, a destination of connection of the mobile terminal being switched from another station to the own station by the ordinary communications for the another handover.

6. The radio base station according to claim 5, wherein after the completion of the another handover, said control unit resumes data communications suspended between the another station and the mobile terminal because of the another handover by using the switched MIMO communications.

7. The radio base station according to claim 5, wherein after the completion of the another handover, said control unit resumes data communications suspended between the another station and the mobile terminal because of the another handover by using ordinary communications continuous from the another handover, determines whether the resumed data communications are normal or not, and if the result of determination is normal, switches the communication mode between the mobile terminal and the own station from the ordinary communications to MIMO communications and continues the resumed data communication by the MIMO communications.

8. The radio base station according to claim 5, wherein the radio base station is a node that is connected to Evolved Universal Terrestrial Radio Access Network (E-UTRAN) of a Long Term Evolution (LTE)/System Architecture Evolution (SAE) network.

9. A mobile terminal comprising
a transmission and reception unit that radioly performs Multi Input Multi Output (MIMO) communications using a plurality of transmission channels and ordinary communications using a single transmission channel,
a control unit starting, when performing a handover to switch a destination of connection to a second radio base station while holding data communications with a first radio base station by MIMO communications, communications pertaining to the handover between the own terminal and each of the first and second radio base stations by ordinary communications, and switching communication mode between the own terminal and the second radio base station from the ordinary communications to NANO communications after completion of the handover.

10. (canceled)

11. (canceled)
